(19) United States
(12) Patent Application Publication
(10) Pub. No.: US 2007/0230054 A1
(43) Pub. Date: Oct. 4, 2007

(54) Magnetic tape

(75) Inventors: Toshiharu Takeda, Odawara-shi (JP); Katsuhiko Meguro, Odawara-shi (JP); Takeshi Nagata, Odawara-shi (JP)

Correspondence Address: SUGHRUE-265550, 2100 PENNSYLVANIA AVE. NW, WASHINGTON, DC, 20037-3213, US

(73) Assignee: FUJIFILM Corporation, Minato-ku (JP)

(21) Appl. No.: 11/727,942

(22) Filed: Mar. 29, 2007

(30) Foreign Application Priority Data
Mar. 29, 2006 (JP) 2006-091796

(51) Int. Cl. G11B 5/78

(52) U.S. Cl. 360/134

(57) ABSTRACT

A magnetic tape including: a nonmagnetic support; a substantially nonmagnetic layer containing nonmagnetic powder and a binder; and a magnetic layer containing ferromagnetic powder and a binder, in this order, wherein the magnetic tape has a coefficient of temperature expansion of from 0 to 10×10⁻⁶/° C. and a coefficient of humidity expansion of 0 to 7×10⁻⁶/% RH each in a transverse direction of the magnetic tape, and the magnetic tape has a dimensional deformation amount of from 0.01 to 0.06% in the transverse direction in case of applying a tensile stress of 1N to the magnetic tape at 60° C. for 50 hours in a longitudinal direction of the magnetic tape.

### FIELD OF THE INVENTION

This invention relates to a particulate magnetic tape having improved dimensional stability in its transverse direction even in preservation under environmental changes in temperature or humidity and a high-temperature environment and therefore having reduced off-track error even at small track widths and capable of high output and high reliability writing and reading.

### BACKGROUND OF THE INVENTION

In recent years, means for rapidly transmitting terabyte-class information have developed remarkably, making it possible to transfer images and data furnishing immense information. With the development, demands for high technology for recording, reproducing, and storing the information have been increasing. Types of media for recording and reproducing information include flexible discs, magnetic drums, hard discs, and magnetic tapes. In particular, magnetic tapes have a high recording capacity per pack and are expected to meet the demands in applications to data backup and the like.

Historical magnetic tapes basically comprise a support and a single layered, relatively thick, e.g., about 2.0 to 3.0 μm thick magnetic layer containing ferromagnetic powder and a binder. The problem associated with this type of magnetic tapes is that they are unable to meet the latest demands for storing vast quantities of data.

JP-A-8-227517 (corresponding to U.S. Pat. No. 5,904,979) proposes a magnetic recording tape for use in a magnetic recording system equipped with a thin film magnetic head. The magnetic tape disclosed has a nonmagnetic support, a lower nonmagnetic layer containing inorganic nonmagnetic powder dispersed in a binder, and a thin upper magnetic layer containing ferromagnetic metal powder dispersed in a binder in the order described. According to the teachings, output reduction caused by thickness loss can be suppressed by reducing the upper magnetic layer thickness (to 0.3 μm), and a high recording density can be attained, allowing for storing larger quantities of data than magnetic tapes having a single layered magnetic layer. JP-A-11-250449 (corresponding to U.S. Pat. No. 6,228,461) also describes a magnetic tape having a lower nonmagnetic layer and an upper magnetic layer.

### SUMMARY OF THE INVENTION

In applications to a linear magnetic recording system, magnetic tapes have shown tendency to have reduced write/read track widths to realize higher recording density and larger recording capacity. A magnetic head moves across the tape (in the vertical direction) to choose a track. As the track width gets narrower, higher precision is required in positioning the head relative to the track position of the tape.

A conventional linear recording system has been designed such that a magnetic head vertically moves between predetermined positions while a magnetic tape runs at a vertical position fixed by guides, etc. However, if a magnetic tape stretches or shrinks with environmental changes in temperature or humidity, or if a tape runs out of expected position, the reduction in track width can cause a read head to stray off the right position of a write track having data recorded, which easily results in output reduction. Hence, a servo control system has recently been introduced to carry out head positioning. In a servo control system, servo signals are recorded in the longitudinal direction of a magnetic tape, based on which the position of a head relative to the tape is detected and controlled so that the head may to be kept at a right position on the running tape.

The servo signals include a plurality of servo bands, each servo band having signals varying in the band width. The position of a read head relative to the servo bands is detected by reading the servo signals. In the tracking control system using a magnetic tape having such servo signals recorded, it is desirable that the spacing between servo bands and the width of each servo band not vary. In other words, it is desirable that the magnetic tape not change in width.

Because magnetic tapes for the above-described linear recording system are used repeatedly and at high running speeds, they are required to have higher dimensional stability than before in not only the transverse but longitudinal directions. In a system using an MR head realizing high density recording, the tension applied to the tape tends to increase so as to secure contact with an MR head. The tape tension increases especially near BOT (beginning of tape) and EOT (end of tape) when the tape stops running. As a result, the magnetic tape may be stretched to cause output reduction. The change in length of the tape leads to change in tape width, which can cause tracking errors particularly in a magnetic tape having the servo signals. Therefore, a magnetic tape for the linear recording system is required to have higher mechanical strength than before in its longitudinal direction. Additionally, it is desirable for a magnetic tape to have a higher output to achieve high density recording.

As a result of the present inventors' study, it has turned out that the magnetic tape of JP-A-8-227517 (corresponding to U.S. Pat. 5,904,979) supra leaves room for further improvement on tracking characteristics and running characteristics for use in the linear recording system. More specifically, it has been revealed that the magnetic tape undergoes relatively large change in width with change in temperature or humidity, which can result in reduction of tracking precision and a failure to obtain sufficient read output even under tracking control based on servo signals. The magnetic tape has also proved to show an increased error rate after repeated running. The magnetic tape of JP-A-11-250449 (corresponding to U.S. Pat. No. 6,228,461) is insufficient in high-output reproduction when applied to high density recording and is still in need of improvement. It is necessary to perform accurate recording on the magnetic tape and to accurately reproduce data recorded therein even after preservation under a severe environment, for example, a high-temperature environment. However, since each of members constituting a magnetic recording medium are generally deformed and thus a dimensional change may occur under the environment, it may be difficult to accurately record and reproduce the data.

An object of the present invention is to provide a magnetic tape which has improved dimensional stability in its width (transverse) direction even in preservation under environmental changes in temperature or humidity and the high-temperature environment and therefore has reduced tracking errors even at small track widths and is capable of high output and high reliability writing and reading.

As a result of further study, the inventors have found that a magnetic tape, the temperature and humidity expansion coefficients of which in its transverse direction are controlled not to exceed the respective given values and the amount of creep which in its transverse direction are controlled not to exceed the given value has improved dimensional stability in its transverse direction and therefore exhibits stable tracking characteristics with reduced off-track error during running despite a small track width.

The present invention provides a magnetic tape including a nonmagnetic support, a substantially nonmagnetic layer containing nonmagnetic powder and a binder and a magnetic layer containing ferromagnetic powder and a binder provided in this order. The magnetic tape has a coefficient of temperature expansion of 0 to 10×10⁻⁶/° C. and a coefficient of humidity expansion of 0 to 7×10⁻⁶/% RH each in its transverse direction, and a dimensional deformation amount of 0.01 to 0.06% in its transverse direction at the time of applying a tensile stress of 1N to the magnetic tape at 60° C. for 50 hours in a longitudinal direction.

The present invention provides a preferred embodiment of the magnetic tape, in which:
(1) the Young's modulus in the longitudinal direction is 6 GPa or higher, or

(2) the magnetic layer has a dry thickness of 10 to 100 nm and a coercive force of 159.2 kA/m (2000 Oe) or higher.

The magnetic tape of the invention hardly suffers from an off-track error even with narrow read/write tracks, has controlled uneven stretching even in preservation under the high-temperature environment, and has improved dimensional stability, thereby achieving high writing and reading reliability. The magnetic tape of the invention is particularly beneficial in application to a servo tracking system. The magnetic tape of the present invention is especially suitable as a tape for recording signals at an a real recording density of 4 to 12 Gbit/inch² or a tape having a track density of 5 ktpi or higher.

### DETAILED DESCRIPTION OF THE INVENTION

The present invention provides a magnetic tape including a nonmagnetic support, a substantially nonmagnetic layer containing nonmagnetic powder and a binder and a magnetic layer containing ferromagnetic powder and a binder, provided in this order. The magnetic tape has a coefficient of temperature expansion of 0 to 10×10⁻⁶/° C. and a coefficient of humidity expansion of 0 to 7×10⁻⁶/% RH each in the transverse direction thereof and has a dimensional deformation amount of 0.01 to 0.06% in its transverse direction at the time of applying a tensile stress of 1N to the magnetic tape at 60° C. for 50 hours in a longitudinal direction.

Means for providing a magnetic tape with the temperature expansion coefficient and the humidity expansion coefficient described above is not particularly limited and include, for example, controlling the Young's moduli of the nonmagnetic support in the longitudinal and transverse directions within respective proper ranges as will be described later in detail. The Young's modulus in the longitudinal direction is preferably 6.0 GPa or more, still preferably 7.0 GPa or more. The Young's modulus in the transverse direction is preferably 8.0 GPa or more, still preferably 9.0 GPa or more, even still preferably 11.0 GPa or more. Means for obtaining a nonmagnetic support with so controlled Young's moduli are not particularly limited and include adjusting stretch ratio, stretch temperature or heat treating temperature in the preparation of the support and/or providing a reinforcing layer on the support. The nonmagnetic support before coating is preferably heat-treated at a temperature of lower than a glass transition temperature (Tg) of the nonmagnetic support by 25° C. in advance so as to meet the dimensional change in the transverse direction of the magnetic tape at the time of applying the tensile stress of 1N to the magnetic tape in the longitudinal direction thereof at 60° C. The heat treatment is preferably carried out at a temperature of lower than the Tg of the nonmagnetic support by 30° C. and it is still preferably carried out at a temperature of lower than the Tg of the nonmagnetic support by 35° C. The lowest limit of a heat treating temperature is in the range of 50 to 700, for example. A heat treating time is in the range of 1 to 240 hours, for example, preferably in the range of 5 to 168 hours, and still preferably in the range of 10 to 120 hours. The heat treating temperature may be lower than 50° C., while the heat treating time becomes even longer. A room temperature is slowly lowered after the heat treatment and then, a coating composition used for forming coating layers is coated and dried. A drying temperature after coating the coating liquids is preferably set so that a web temperature does not exceed the Tg of the nonmagnetic support. When the web temperature exceeds the Tg of the nonmagnetic support, the creep deformation amount of the invention may not be met. The Tg disclosed in the invention is a value measured by means of a temperature of a maximum loss elastic modulus in dynamic viscoelasticity measurement at 10 Hz. The temperature of the maximum loss elastic modulus is acquired at 10 Hz in the range of 15 to 200° C. by using a device for measuring the known dynamic viscoelasticity, for example, DMS6100 connected to EXSTART6000 station, which is manufactured by Seiko Instruments Inc.

The reinforcing layer is made out of a metallic material selected from metals, semimetals, alloys, and their oxides and composites. Examples include metals such as Al, Cu, Zn, Sn, Ni, Ag, Co, Fe, and Mn; semimetals such as Si, Ge, As, Sc, and Sb; alloys of the metals or semimetals such as Fe—Co, Fe—Ni, Co—Ni, Fe—Co—Ni, Fe—Cu, Co—Cu, Co—Au, Co—Y, Co—La, Co—Pr, Co—Gd, Co—Sm, Co—Pt, Ni—Cu, Mn—Bi, Mn—Sb, Mn—Al, Fe—Cr, Co—Cr, Ni—Cr, Fe—Co—Cr, and Ni—Co—Cr; oxides obtained by vacuum depositing the metals or semimetals while introducing oxygen gas; and composites of the metals or semimetals such as Fe—Si—O, Si—C, Si—N, Cu—Al—O, Si—N—O, and Si—C—O.

Methods of forming the reinforcing layer are not limited. Vacuum deposition is commonly used. Sputtering or ion plating is also useful.

The thickness of the reinforcing layer is adjusted according to the Young's moduli of the support per se on which the reinforcing layer is to be provided. The thickness of the reinforcing layer is preferably 20 to 500 nm, still preferably 20 to 300 nm, even still preferably 30 to 100 nm. The reinforcing layer may have either a single-layered or a multi-layered structure.

In view of the stiffness of the resulting reinforced support, it is preferred for the reinforcing layer to contain an oxide of a metallic material selected from metals, semimetals and alloys and to have an inhomogeneous oxygen distribution such that the oxygen concentration is higher near the surface of the reinforcing layer than in the other portion. It is more preferred that the oxygen concentration be higher not only near the surface of the reinforcing layer but also near the interface between the reinforcing layer and the support than in other portion. The reinforcing layer with such an inhomogeneous oxygen distribution can be obtained by forcibly oxidizing the exposed surface of the layer with an oxidizing gas either during or after the formation of the reinforcing layer. Measurement of the oxygen concentration distribution in the reinforcing layer can be made in the thickness direction by Auger electron spectroscopy. The expression “oxygen concentration is higher” as used herein preferably means that the difference in oxygen concentration is 10 atom % or more.

The reinforcing layer can be provided on one or both sides of the nonmagnetic support, and is preferably provided on at least the side of the magnetic layer.

### I. Nonmagnetic Support

Known materials can be used as the nonmagnetic support to be used in the invention. Such materials include polyesters, e.g., polyethylene terephthalate and polyethylene naphthalate, polyolefins, cellulose triacetate, polycarbonate, polyamide, polyimide, polyamide-imide, polysulfone, polyaramid, aromatic polyamide, and polybenzoxazole. High strength supports made of polyethylene naphthalate, polyamide, etc. are preferred. Where necessary, laminate type supports with surface roughness varied between the magnetic layer side and the opposite side, such as the one disclosed in JP-A-3-224127, may be used. The support may previously be subjected to a corona discharge treatment, a plasma treatment, an adhesion enhancing treatment, a heat treatment, a dustproof treatment, etc. An aluminum support or a glass support may also be used.

Polyester supports (hereinafter, “polyesters”) are still preferred. The polyesters used as a support include those composed of a dicarboxylic acid component and a diol component, such as polyethylene terephthalate and polyethylene naphthalate.

Examples of dicarboxylic acids that are suitable as a main dicarboxylic acid component of polyesters are terephthalic acid, isophthalic acid, phthalic acid, 2,6-naphthalenedicarboxylic acid, 2,7-naphthalenedicarboxylic acid, diphenylsulfonedicarboxylic acid, diphenyl ether dicarboxylic acid, diphenylethanedicarboxylic acid, cyclohexanedicarboxylic acid, diphenyldicarboxylic acid, diphenyl thioether dicarboxylic acid, diphenyl ketone dicarboxylic acid, and phenylindanedicarboxylic acid.

Examples of the diol component of the polyesters include ethylene glycol, propylene glycol, tetramethylene glycol, cyclohexanedimethanol, 2,2-bis(4-hydroxyphenyl)propane, 2,2-bis(4-hydroxyethoxyphenyl)propane, bis(4-hydroxyphenyl)sulfone, bisphenolfluorene dihydroxyethyl ether, diethylene glycol, neopentyl glycol, hydroquinone, and cyclohexanediol.

Of these polyesters preferred are those composed of terephthalic acid and/or 2,6-naphthalenedicarboxylic acid as a main dicarboxylic acid component and ethylene glycol and/or 1,4-cyclohexanedimethanol as a main diol component for their transparency, mechanical strength, and dimensional stability.

Still preferred are polyesters containing polyethylene terephthalate or polyethylene 2,6-naphthalate as a main constituent, co-polyesters composed of terephthalic acid, 2,6-naphthalenedicarboxylic acid, and ethylene glycol, and polyblends mainly of two or more of these polyesters. Particularly preferred are polyesters containing polyethylene 2,6-naphthalate as a main constituent.

The polyester support may be a biaxially film or a laminate film.

The polyester may contain an additional component as a comonomer or an additional polyester. Such an additional component or polyester can be chosen from the above recited dicarboxylic acid components, diol components, and polyesters prepared therefrom.

To provide a polyester support resistant to delamination, the polyester may have another component copolymerized, such as an aromatic dicarboxylic acid having a sulfonate group or an ester-forming derivative thereof, a dicarboxylic acid having a polyoxyalkylene group or an ester-forming derivative thereof, or a diol having a polyoxyalkylene group.

From the perspective of copolymerizability in the preparation of polyester and transparency of the resulting film, preferred of the comonomer components recited above are 5-sodium sulfoisophthalic acid, 2-sodium sulfoterephthalic acid, 4-sodium sulfophthalic acid, 4-sodium sulfo-2,6-naphthalenedicarboxylic acid, their analogues with sodium replaced by other metal (e.g., potassium or lithium), an ammonium salt, a phosphonium salt, etc., and ester-forming derivatives of these compounds; polyethylene glycol, polytetramethylene glycol, a polyethylene glycol-polypropylene glycol copolymer, and the recited diol compounds with the hydroxyl group at both terminals thereof converted to a carboxyl group by, for example, oxidation. The amount of the comonomer component used for the purpose described is preferably 0.1 to 10 mol % based on the dicarboxylic acid component constituting the polyester.

To provide a polyester support with improved heat resistance, the polyester may have a bisphenol compound or a compound having a naphthalene or cyclohexane ring copolymerized in an amount preferably of 1 to 20 mol % based on the dicarboxylic acid component constituting the polyester.

The process of synthesizing the polyester used in the invention is not particularly limited. A known technique can be followed, including a direct esterification process in which a dicarboxylic acid component and a diol component are directly subjected to esterification and an interesterification process in which a dialkyl ester as a dicarboxylic acid component is interesterified with a diol component, and the reaction mixture is heated under reduced pressure to remove excess diol. If desired, a catalyst for interesterification or polymerization or a heat stabilizer may be added to the reaction system.

One or more additives may be added to the reaction system in an appropriate stage of synthesis. The additives include anti-coloring agents, antioxidants, nucleating agents, slip agents, stabilizers, anti-blocking agents, UV absorbers, viscosity modifiers, antifoam clarifiers, antistatic agents, pH adjusters, dyes, pigments, and terminators.

A filler may be added to the polyester. Types of the filler includes inorganic powders, such as spherical silica, colloidal silica, titanium oxide, and alumina; and organic powders, such as crosslinked polystyrene and silicone resin.

In order to provide a high rigidity support, the polyester film may be highly stretched or laminated with a layer of metal, semi-metal or an oxide thereof.

The nonmagnetic polyester support preferably has a thickness of 3 to 80 μm, still preferably 3 to 50 μm, even still preferably 3 to 8 μm. The surface of the nonmagnetic support preferably has an average surface roughness (SRa; arithmetic mean deviation from mean plane) of 6 nm or less, still preferably 4 nm or less, as measured with HD2000 from Wyko.

The magnetic recording medium of the invention has a magnetic layer containing a ferromagnetic powder and a binder formed on at least one side of the nonmagnetic support. The magnetic recording medium of the invention also has a nonmagnetic layer (lower layer) that is substantially nonmagnetic provided between the nonmagnetic support and the magnetic layer.

### II. Magnetic Layer

The ferromagnetic powder used in the magnetic layer preferably has a volume of 1,000 to 20,000 nm³, still preferably 2,000 to 8,000 nm³, per particle. With the particle size falling within that range, reduction of magnetic characteristics due to thermal fluctuation is minimized effectively, and a good C/N (S/N) is obtained while securing low noise. Examples of the ferromagnetic powder preferably include, but are not limited to, ferromagnetic metal powder, hexagonal ferrite powder, and iron nitride based powder.

The volume of an acicular ferromagnetic powder particle is calculated from the length (major axis length) and breadth (minor axis length), assuming the shape of the particle as a circular cylinder.

The volume of a platy particle is obtained from the length (diameter) and thickness, assuming the shape of the particle as a prism (the shape of hexagonal ferrite powder is assumed to be a hexagonal prism).

The volume of an iron nitride based powder particle is obtained by assuming the shape of the particle as a sphere.

The size of the magnetic particle can be determined as follows. An appropriate amount of the magnetic layer is stripped off a magnetic recording medium. In a glass tube are put 30 to 70 mg of the stripped magnetic layer and n-butylamine. The glass tube is sealed and set in a pyrolyzer and heated at 140° C. for about one day. After cooling, the contents are taken out from the glass tube and separated into liquid and solid by centrifugation. The solid is washed with acetone to obtain a powder sample for TEM. The particles of the sample are photographed by a transmission electron microscope H-9000 from Hitachi, Ltd. at a magnification of 100,000 and printed on photographic paper to a total magnification of 500,000. Objective magnetic particles are selected from the micrograph, the contour of the particles is traced with a digitizer, and the size of each particle is measured with image analysis software KS-4000 from Carl Zeiss. Five hundred particles are measured to obtain an average particle size.

The ferromagnetic metal powder that can be used in the magnetic layer is not particularly limited as long as it contains Fe, inclusive of an Fe alloy, as a main ingredient. A ferromagnetic alloy powder having α-Fe as a main ingredient is preferred. The ferromagnetic metal powder may contain, in addition to prescribed atoms, Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, etc. Ferromagnetic powders containing at least one of Al, Si, Ca, Y, Ba, La, Nd, Co, Ni, and B in addition to α-Fe, particularly those containing at least one of Co, Al, and Y in addition to α-Fe are preferred. More specifically, ferromagnetic metal powders containing 10 to 40 at % of Co, 2 to 20 at % of Al, and 1 to 15 at % of Y, each based on Fe, are preferred.

The ferromagnetic metal powder may previously be treated with a dispersant, a lubricant, a surface active agent, an antistatic agent, etc. (described later) before being dispersed. The ferromagnetic metal powder may contain a small amount of water, a hydroxide or an oxide. The water content of the ferromagnetic metal powder preferably ranges from 0.01% to 2% by weight. The water content of the ferromagnetic metal powder is preferably optimized according to the kind of the binder to be combined with. The pH of the ferromagnetic metal powder, which is preferably optimized according to the kind of the binder to be combined with, usually ranges from 6 to 12, preferably 7 to 11. The ferromagnetic metal powder may contain inorganic soluble ions, such as Na, Ca, Fe, Ni, Sr, NH₄, SO₄, Cl, NO₂, and NO₃ ions. While the absence of such ions is essentially desirable, presence in a total concentration up to about 300 ppm is little influential on the characteristics. The void of the ferromagnetic metal powder is preferably as small as possible. The void is preferably 20% by volume or less, still preferably 5% by volume or less.

The ferromagnetic metal powder preferably has an average particle length of 10 to 100 nm, still preferably 20 to 70 nm, even still preferably 30 to 60 nm.

The ferromagnetic metal powder preferably has a crystallite size of 7 to 18 nm, still preferably 8 to 14 nm, even still preferably 9 to 13 nm. The crystallite size is an average calculated from a half value width of the X-ray diffraction peak by Scherrer's formula. X-Ray diffractometry is carried out using RINT 2000 from Rigaku Co., Ltd. equipped with a CuKαl ray source at a tube voltage of 50 kV and a tube current of 300 mA.

The ferromagnetic metal powder preferably has a BET specific surface area (SBET) of 45 to 120 m²/g, still preferably 50 to 100 m²/g, so as to secure both satisfactory surface properties and low noise. Noise will increase at an SBET less than 45 m²/g, and surface smoothness is hardly secured at an SBET more than 120 m²/g.

The pH of the ferromagnetic metal powder, which is preferably optimized according to the kind of the binder to be combined with, usually ranges from 4 to 12, preferably 6 to 10. If desired, the ferromagnetic metal powder can be surface treated with 0.1% to 10% by weight, based on the ferromagnetic powder, of Al, Si, P or an oxide thereof, whereby adsorption of a lubricant, such as a fatty acid, is controlled not to exceed 100 mg/M². The ferromagnetic metal powder may contain inorganic soluble ions, such as Na, Ca, Fe, Ni, and Sr ions. Presence of up to about 200 ppm of such ions is little influential on the characteristics.

The ferromagnetic metal powder can have an acicular shape, a spindle shape, a platy shape or any other general shape as long as the particle volume falls within the above-specified ranges. Acicular ferromagnetic metal particles are preferred. Acicular ferromagnetic metal particles preferably have an average aspect ratio of 4 to 12, still preferably 5 to 8. The ferromagnetic metal powder preferably has a coercive force Hc of 159.2 to 278.5 kA/m (2000 to 3500 Oe), still preferably 167.1 to 238.7 kA/m (2100 to 3000 Oe), a saturation flux density of 150 to 300 mT (1500 to 3000 G), still preferably 160 to 290 mT, and a saturation magnetization as of 90 to 140 A·m²/kg (90 to 140 emu/g), still preferably 100 to 120 A·m²/kg. The SFD (switching field distribution) of the magnetic powder itself is preferably as small as possible. A preferred SFD is 0.6 or smaller. Ferromagnetic metal powder having an SFD of 0.6 or smaller shows good electromagnetic characteristics, high output, and a sharp magnetization reversal with a small peak shift, which is advantageous for high density digital magnetic recording. The coercivity distribution can be narrowed by, for example, using goethite with a narrow size distribution, using mono-dispersed α-Fe₂O₃ particles, or preventing sintering of particles in the preparation of the ferromagnetic metal powder.

The ferromagnetic metal powder can be prepared by known processes, such as reduction of hydrated iron oxide having been treated for sintering prevention or iron oxide with a reducing gas (e.g., hydrogen) into Fe or Fe—Co particles; reduction of a composite organic acid salt (mainly an oxalate) with a reducing gas (e.g., hydrogen); pyrolysis of a metal carbonyl compound; reduction of a ferromagnetic metal in the form of an aqueous solution by adding a reducing agent (e.g., sodium borohydride, a hypophosphite or hydrazine); and vaporization of a metal in a low-pressure inert gas. The resulting ferromagnetic metal powder may be subjected to a known slow oxidation treatment. For example, ferromagnetic metal powder obtained by reducing hydrated iron oxide or iron oxide with a reducing gas, such as hydrogen, is treated in an atmosphere having a controlled oxygen to inert gas ratio at a controlled temperature for a controlled time to form an oxide film on its surface. This slow oxidation technique is preferred for reduced involvement of demagnetization.

Examples of the hexagonal ferrite powder that can be used in the invention include barium ferrite, strontium ferrite, lead ferrite, and calcium ferrite, and Co-substituted materials thereof. Specific examples are barium ferrite and strontium ferrite of magnetoplumbite type; magnetoplumbite type ferrites coated with spinel; and barium ferrite and strontium ferrite of magnetoplumbite type containing a spinel phase in parts. These ferrites may contain additional elements, such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, and Nb. Usually, ferrites doped with Co—Zn, Co—Ti, Co—Ti—Zr, Co—Ti—Zn, Ni—Ti—Zn, Nb—Zn—Co, Sb—Zn—Co, Nb—Zn, etc. can be used. Depending on the raw materials or the processes adopted, some ferrites can contain intrinsic impurity. With reference to other preferred atoms and their contents in the ferrite powder, the description given above about the ferromagnetic metal powder applies.

The hexagonal ferrite powder preferably has such a particle size as to satisfy the above-recited volume conditions. Specifically, the hexagonal ferrite powder preferably has an average length of 10 to 50 nm, still preferably 15 to 40 nm, even still preferably 20 to 30 nm.

The average aspect ratio (length to breadth or thickness ratio) of the hexagonal particles is desirably 1 to 15, more desirably 1 to 7. With the average aspect ratio being 1 to 15, sufficient orientation can be obtained while assuring a high packing density in the magnetic layer, and an increase of noise due to particles' stacking can be prevented. The particles within the above-recited size ranges preferably have a BET specific surface area (SBET) of 40 m²/g or more, still preferably 40 to 200 m²/g, even still preferably 60 to 100 m²/g.

It is usually preferred for the hexagonal ferrite powder to have as narrow a particle size (length and thickness) distribution as possible. Although it is difficult to quantify the length and thickness of platy particles, comparison can be made among, e.g., 500 particles randomly chosen from a transmission electron micrograph. While the size distribution is mostly not normal, the coefficient of variation represented by the standard deviation a divided by the mean (a/mean) is 0.1 to 1.0. In order to make the particle size distribution sharper, the reaction system for particle formation is made uniform as much as possible, and the particles produced are subjected to treatment for distribution improvement. For example, selective dissolution of ultrafine particles in an acid solution is among known treatments.

The coercive force Hc of the hexagonal ferrite powder used in the invention is preferably 143.3 to 318.5 kA/m (1800 to 4000 Oe), still preferably 159.2 to 238.9 kA/m (2000 to 3000 Oe), even still preferably 191.0 to 214.9 kA/m (2200 to 2800 Oe). The coercive force Hc can be controlled by the particle size (length and thickness), the kinds and amounts of constituent elements, the substitution site of elements, conditions of particle forming reaction, and the like.

The hexagonal ferrite powder preferably has a saturation magnetization σs of 30 to 80 Am²/kg (emu/g). A relatively high as within that range is desirable. A saturation magnetization tends to decrease as the particle size becomes smaller. It is well known that the saturation magnetization can be improved by using a magnetoplumbite type ferrite combined with a spinel type ferrite or by properly selecting the kinds and amounts of constituent elements. It is also possible to use a W-type hexagonal ferrite powder.

For the purpose of improving dispersibility, it is practiced to treat magnetic powder with a substance compatible with a binder resin, a dispersing medium. The surface treating substance includes organic or inorganic compounds. Typical examples are oxides or hydroxides of Si, Al or P, silane coupling agents, and titanium coupling agents. The surface treating substance is usually used in an amount of 0.1% to 10% by weight based on the magnetic powder. The pH of the ferrite powder is of importance for dispersibility. The pH usually ranges from about 4 to 12. While the pH should be optimized according to the binder resin, a pH of about 6 to 11 is recommended from the standpoint of chemical stability and storage stability of the magnetic recording medium. The water content of the ferrite powder is also influential on dispersibility. While varying according to the kind of the binder resin as a dispersing medium, the optimal water content usually ranges from 0.01% to 2.0% by weight.

The hexagonal ferrite powder for use in the invention can be prepared by, for example, (1) a process by controlled crystallization of glass which includes the steps of blending barium oxide, iron oxide, an oxide of a metal that is to substitute iron, and a glass forming oxide (e.g., boron oxide) in a ratio providing a desired ferrite composition, melting the blend, rapidly cooling the melt into an amorphous solid, re-heating the solid, washing and grinding the solid to obtain a barium ferrite crystal powder, (2) a hydrothermal process which includes the steps of neutralizing a solution of barium ferrite-forming metal salts with an alkali, removing by-products, heating in a liquid phase at 100° C. or higher, washing, drying, and grinding to obtain a barium ferrite crystal powder, and (iii) a coprecipitation process which includes the steps of neutralizing a solution of barium ferrite-forming metal salts with an alkali, removing by-products, drying, treating at 1100° C. or lower, and grinding to obtain a barium ferrite crystal powder. If desired, the ferromagnetic hexagonal ferrite powder may be surface treated with 0.1% to 10% by weight of Al, Si, P, an oxide thereof, etc. to control adsorption of a lubricant, such as a fatty acid, not to exceed 100 mg/m². Although it is essentially desirable for the ferromagnetic hexagonal ferrite powder to be free from inorganic soluble ions, such as Na, Ca, Fe, Ni, and Sr ions, presence of up to 200 ppm of such ions is little influential on the characteristics.

The iron nitrogen based magnetic powder contains an Fe₁₆N₂ phase as a main ingredient. In the case where the Fe₁₆N₂ phase of the iron nitride based magnetic powder is coated with any surface layer, the term “average particle size” as used with respect to the Fe₁₆N₂ phase means the average particle size of the Fe₁₆N₂ particle itself.

It is preferred that the iron nitride based powder be preferably free from other iron nitride phase than the Fe₁₆N₂ phase. This is because the crystalline magnetic anisotropy of an Fe₁₆N₂ phase is as high as 2×10⁶ to 7×10⁶ erg/cc whereas that of other iron nitride phases (e.g., Fe₄N phase and Fe₃N phase) is about 1×10⁵ erg/cc. Iron nitride based powder free from other iron nitride phase than an Fe₁₆N₂ phase is therefore capable of maintaining high coercivity even after pulverized. The high crystalline magnetic anisotropy of an Fe₁₆N₂ phase is attributed to its crystal structure. The crystal structure of an Fe₁₆N₂ phase is body-centered tetragonal with N atoms regularly occupying the octahedral interstitial sites of Fe. The strain by the interstitial N atoms is considered to be a cause of the high crystalline magnetic anisotropy. The easy magnetization axis of an Fe₁₆N₂ phase is the c axis extended by nitriding.

The particles containing an Fe₁₆N₂ phase preferably has an elliptic shape, more preferably a spherical shape, for the following reason. Because one of the three equivalent axes of a cubic α-Fe crystal is selected by nitriding to become the c axis (easy magnetization axis), needle-like particles containing an Fe₁₆N₂ phase include both particles with the easy magnetization axis in the major axial direction and those with the easy magnetization axis in the minor axial direction, which is unfavorable. In view of this, the aspect ratio (length/breadth) of the particles is preferably 2 or smaller (e.g., 1 to 2), more preferably 1.5 or smaller (e.g., 1 to 1.5).

The particle size is governed by the particle size of iron particles before nitriding. The particles are preferably monodisperse because use of monodisperse particles results in low medium noise. The particle size of the iron nitride based magnetic powder containing an Fe₁₆N₂ phase as a main phase is governed by the particle size of iron particles before nitriding, and the iron particles to be nitrided is preferably monodisperse. This is because the degree of nitriding varies depending on the particle size of the iron particles, resulting in varied magnetic characteristics among particles. In view of this, too, the iron nitride based magnetic powder is preferably monodisperse.

The magnetic Fe₁₆N₂ phase has a particle size of 9 to 11 nm. Too small particles receive large influences of thermal fluctuation to become superparamagnetic, i.e., unsuitable for magnetic recording. Furthermore, with a decrease in particle size, coercivity in high speed recording with a head becomes high due to magnetic viscosity, which makes recording difficult. If the particle size is too large, on the other hand, saturation magnetization increases, resulting in too high coercivity during recording, which makes recording difficult. Too large a particle size also causes high particle noise. The particles are preferably monodisperse; for monodisperse particles generally reduce medium noise. A coefficient of particle size variation is 15% or less, preferably 2% to 15%, still preferably 10% or less, even still preferably 2 to 10%.

The individual iron nitride based magnetic particles having Fe₁₆N₂ as a main phase are preferably coated with an oxide film because Fe₁₆N₂ nanoparticles are susceptible to oxidation and need handling in a nitrogen atmosphere.

The oxide film preferably contains a rare earth element and/or an element selected from silicon and aluminum so as to assume the same surface as conventional, so-called metal particles primarily containing Fe and Co and to exhibit good affinity to processing steps conventionally dealing with the metal particles. Preferred examples of the rare earth element include Y, La, Ce, Pr, Nd, Sm, Tb, Dy, and Gd. Y is particularly preferred for its dispersibility.

The oxide layer may further contain boron or phosphorus according to necessity. The oxide layer may furthermore contain carbon, calcium, magnesium, zirconium, barium, strontium, etc. as an effective element. A combined use of a rare earth element and/or silicon or aluminum with these other elements will bring about better shape retention and dispersibility.

The total content of the rare earth element, boron, silicon, aluminum, and phosphorus in the surfacing oxide layer is preferably 0.1 to 40.0 atom %, still preferably 1.0 to 30.0 atom %, even still preferably 3.0 to 25.0 atom %, based on iron. When the total content of these elements is too small, it is difficult to form the surfacing oxide layer, and the magnetic particles tend to have reduced magnetic anisotropy and be oxidized easily. When the total content is too high, excessive reduction in saturation magnetization tends to result.

The thickness of the oxide layer is preferably 1 to 5 nm, still preferably 2 to 3 nm. Magnetic particles with a thinner oxide layer are liable to oxidation. A thicker oxide layer makes it difficult to obtain substantially small particles.

The iron nitride based magnetic powder primarily containing an Fe₁₆N₂ phase preferably has a coercive force (Hc) of 79.6 to 318.4 kA/m (1,000 to 4,000 Oe), still preferably 159.2 to 278.6 kA/m (2000 to 3500 Oe), even sill preferably 197.5 to 237 kA/m (2500 to 3000 Oe). Particles having too low a coercive force are susceptible to influences from neighboring recording bits in the case of in-plane recording and therefore apt to be unsuitable to high density recording. Particles having too high a coercive force tend to make recording difficult.

The iron nitride based magnetic powder primarily containing an Fe₁₆N₂ phase preferably has a saturation magnetization of 80 to 160 Am²/kg (80 to 160 emu/g), still preferably 80 to 120 Am²/kg (80 to 120 emu/g). Too low a saturation magnetization can result in weak signals. Particles with too high a saturation magnetization are susceptible to influences from neighboring recording bits in the case of in-plane recording and therefore apt to be unsuitable to high density recording. The iron nitride based powder preferably has a squareness of 0.6 to 0.9.

The BET specific surface area (SBET) is preferably 40 to 100 m²/g. Particles with too small an SBET have too large a particle size and can cause particle noise and reduce the surface smoothness of the magnetic layer to reduce the read output. Particles with too large an SBET are liable to agglomerate and difficult to be dispersed uniformly, making it difficult to obtain a smooth surface.

The iron nitride based magnetic powder particles have an average particle size of 30 nm or smaller, preferably 5 to 25 nm, still preferably 10 to 20 nm.

The iron nitride based particles can be produced by known processes, for example, the process of WO 2003/079332.

The magnetic tape according to the invention is applicable as video tape, computer tape, etc.

### III. Binder

Known techniques relating to magnetic and nonmagnetic layers including binders, lubricants, dispersing agents, additives, solvents, methods of dispersing, and the like are useful in the present invention. In particular, known techniques about a magnetic layer are applied to the amounts and kinds of the binder, additives, and dispersing agents are applicable to the present invention.

Binders used in the present invention include known thermoplastic resins, thermosetting resins, reactive resins, and mixtures thereof. The thermoplastic resins to be used have a glass transition temperature (Tg) of −1000 to 1500, a number average molecular weight of 1,000 to 200,000, preferably 10,000 to 100,000, and a degree of polymerization of about 50 to 1000.

Examples of such thermoplastic resins include homo- or copolymers containing a unit derived from vinyl chloride, vinyl acetate, vinyl alcohol, maleic acid, acrylic acid, an acrylic ester, vinylidene chloride, acrylonitrile, methacrylic acid, a methacrylic ester, styrene, butadiene, ethylene, vinyl butyral, vinyl acetal or a vinyl ether; polyurethane resins, and various types of rubber resins.

Examples of useful thermosetting or reactive resins include phenolic resins, epoxy resins, thermosetting polyurethane resins, urea resins, melamine resins, alkyd resins, reactive acrylic resins, formaldehyde resins, silicone resins, epoxy-polyamide resins, polyester resin/isocyanate prepolymer mixtures, polyester polyol/polyisocyanate mixtures, and polyurethane/polyisocyanate mixtures. For the details of these binder resins, Plastic Handbook published by Asakura Shoten can be referred to. Known electron beam curing resins are also useful as a binder. Examples of, and process of producing, such electron beam curing resins are described in JP-A-62-256219.

The above-described binder resins can be used either individually or as a combination thereof. Examples of preferred binder systems include combinations of a polyurethane resin and at least one vinyl chloride resin selected from polyvinyl chloride, vinyl chloride-vinyl acetate copolymers, vinyl chloride-vinyl acetate-vinyl alcohol copolymers, and vinyl chloride-vinyl acetate-maleic anhydride copolymers, and the combinations further combined with a polyisocyanate compound.

The polyurethane resin may have known structures, such as polyester polyurethane, polyether polyurethane, polyether polyester polyurethane, polycarbonate polyurethane, polyester polycarbonate polyurethane, and polycaprolactone polyurethane. In order to ensure dispersing capabilities for powders and durability of the magnetic recording medium according to necessity, it is preferred to introduce into the above-recited binder resins at least one polar group by copolymerization or through addition reaction, the polar group being selected from —COOM, —SO₃M, —OSO₃M, —P═O(OM)₂, —O—P=O(OM)₂ (wherein M is a hydrogen atom or an alkali metal), —OH, —NR₂, —N⁺R₃ (wherein R is a hydrocarbon group), an epoxy group, —SH, —CN, etc. The amount of the polar group to be introduced is preferably 10⁻¹ to 10⁻⁸ mol/g, still preferably 10⁻² to 10⁻⁶ mol/g.

Examples of commercially available binder resins useful in the invention are VAGH, VYHH, VMCH, VAGF, VAGD, VROH, VYES, VYNC, VMCC, XYHL, XYSG, PKHH, PKHJ, PKHC, and PKFE (from Union Carbide Corp.); MPR-TA, MPR-TA5, MPR-TAL, MPR-TSN, MPR-TMF, MPR-TS, MPR-TM, and MPR-TAO (from Nisshin Chemical Industry Co., Ltd.); 1000W, DX80, DX81, DX82, DX83, and 100FD (from Denki Kagaku Kogyo K.K.); MR-104, MR-105, MR110, MR100, MR555, and 400X-110A (from Zeon Corp.); Nipporan N2301, N2302, and N2304 (from Nippon Polyurethane Industry Co., Ltd.); Pandex T-5105, T-R3080, and T-5201, Barnock D-400 and D-210-80, and Crisvon 6109 and 7209 (from Dainippon Ink & Chemicals, Inc.); Vylon UR8200, UR8300, UR-8700, RV530, and RV280 (from Toyobo Co., Ltd.); Daiferamin 4020, 5020, 5100, 5300, 9020, 9022, and 7020 (from Dainichiseika Color & Chemicals Mfg. Co., Ltd.); MX5004 (from Mitsubishi Chemical Corp.); Sanprene SP-150 (from Sanyo Chemical Industries, Ltd.); and Saran F310 and F210 (from Asahi Chemical Industry Co., Ltd.).

The amount of the binder in the magnetic layer and the nonmagnetic layer is 5% to 50% by weight, preferably 10% to 30% by weight, based on the magnetic powder or nonmagnetic powder. When a vinyl chloride resin and a polyurethane resin are used in combination, their amounts are selected from a range of 5% to 30% by weight and a range of 2% to 20% by weight, respectively. When the combination is further combined with a polyisocyanate, the polyisocyanate is preferably used in an amount of from 2 to 20% by weight. In case where head corrosion by a trace amount of released chlorine is expected to occur, polyurethane alone or a combination of only polyurethane and polyisocyanate can be used. The polyurethane to be used preferably has a Tg of −50° to 150° C., preferably 0° to 100° C., an elongation at break of 100% to 2000%, a stress at rupture of 0.05 to 10 kg/mm², and a yield point of 0.05 to 10 kg/mm².

Examples of the polyisocyanate that can be used in the invention include tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, and triphenylmethane trilsocyanate. Further included are reaction products between these isocyanate compounds and polyols and polyisocyanates produced by condensation of the isocyanates. Examples of commercially available polyisocyanates that can be used in the invention are Coronate L, Coronate HL, Coronate 2030, Coronate 2031, Millionate MR, and Millionate MTL (from Nippon Polyurethane Industry Co., Ltd.); Takenate D-102, Takenate D-110N, Takenate D-200, and Takenate D-202 (from Takeda Chemical Industries, Ltd.); and Desmodur L, Desmodur IL, Desmodur N, and Desmodur HL (from Sumitomo Bayer Urethane Co., Ltd.). They can be used either individually or as a combination of two or more thereof taking advantage of difference in curing reactivity.

### IV. Additive

The magnetic layer can contain additives, such as abrasives, lubricants, dispersing agents or dispersing aids, antifungals, antistatics, antioxidants, solvents, and carbon black, according to necessity. Examples of such additives include molybdenum disulfide, tungsten disulfide, graphite, boron nitride, graphite fluoride, silicone oils, polar group-containing silicones, fatty acid-modified silicones, fluorine-containing silicones, fluorine-containing alcohols, fluorine-containing esters, polyolefins, polyglycols, polyphenyl ethers; aromatic ring-containing organic phosphonic acids, such as phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, and nonylphenylphosphonic acid, and alkali metal salts thereof; alkylphosphonic acids, such as octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, and isoeicosylphosphonic acid, and alkali metal salts thereof; aromatic phosphoric acid esters, such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, toluyl phosphate, xylyl phosphate, ethylphenylphosphate, cumenylphosphate, propylphenyl phosphate, butylphenyl phosphate, heptylphenyl phosphate, octylphenyl phosphate, and nonylphenyl phosphate, and alkali metal salts thereof; alkyl phosphates, such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicosyl phosphate, and alkali metal salts thereof; alkylsulfonic esters and alkali metal salts thereof; fluorine-containing alkylsulfuric esters and alkali metal salts thereof; monobasic fatty acids having 10 to 24 carbon atoms, either saturated or unsaturated and straight chain or branched, such as lauric acid, myristic acid, palmitic acid, stearic acid, behenic acid, oleic acid, linoleic acid, linolenic acid, elaidic acid, and erucic acid, and metal salts thereof; mono-, di- or higher esters of fatty acids prepared between monobasic fatty acids having 10 to 24 carbon atoms, either saturated or unsaturated and straight-chain or branched, and mono- to hexahydric alcohols having 2 to 22 carbon atoms (either saturated or unsaturated and straight-chain or branched), alkoxyalcohols having 12 to 22 carbon atoms (either saturated or unsaturated and straight-chain or branched) or monoalkyl ethers of alkylene oxide polymers, such as butyl stearate, octyl stearate, amyl stearate, isooctyl stearate, octyl myristate, butyl laurate, butoxyethyl stearate, anhydrosorbitol monostearate, and anhydrosorbitol tristearate; fatty acid amides having 2 to 22 carbon atoms; and aliphatic amines having 8 to 22 carbon atoms. The alkyl, aryl or aralkyl moiety of the above-recited additive compounds may be replaced with a nitro group, a halogen atom (e.g., F, Cl or Br), a halogenated hydrocarbon group (e.g., CF₃, CCl₃ or CBr₃) or a like substituent.

Examples of surface active agents that can be used as additives include nonionic ones, such as alkylene oxide types, glycerol types, glycidol types, and alkylphenol ethylene oxide adducts; cationic ones, such as cyclic amines, ester amides, quaternary ammonium salts, hydantoin derivatives, heterocyclic compounds, phosphonium salts, and sulfonium salts; anionic ones containing an acidic group, such as a carboxyl group, a sulfonic acid group or a sulfuric ester group; and amphoteric ones, such as amino acids, aminosulfonic acids, amino alcohol sulfuric or phosphoric esters, and alkyl betaines. For the details of the surface active agents, refer to Kaimen Kasseizai Binran published by Sangyo Tosho K.K.

The above-described lubricants, antistatic agents, and like additives do not always need to be 100% pure and may contain impurities, such as isomers, unreacted materials, by-products, decomposition products, and oxides. The proportion of the impurities is preferably 30% by weight at the most, still preferably 10% by weight or less.

Specific examples of the additives are NAA-102, hardened castor oil fatty acids, NAA-42, Cation SA, Nymeen L-201, Nonion E-208, Anon BF, and Anon LG (all available from NOF Corp.); FAL 205 and FAL-123 (from Takemoto Yushi K.K.); Enujelv OL (from New Japan Chemical Co., Ltd.), TA-3 (from Shin-Etsu Chemical Industry Co., Ltd.), Armid P (from Lion Akzo Co., Ltd.), Duomeen TDO (from Lion Corp.), BA41G (from Nisshin Oil Mills, Ltd.); and Profan 2012E, Newpol PE 61, and Ionet MS400 (from Sanyo Chemical Industries, Ltd.).

If desired, the magnetic layer can contain carbon black. Types of carbon black that can be used in the magnetic layer include furnace black for rubber, thermal black for rubber, carbon black for color, and acetylene black. The carbon black preferably has a specific surface area of 5 to 500 m²/g, a dibutyl phthalate (DBP) absorption of 10 to 400 ml/100 g, an average particle size of 5 to 300 nm, a pH of 2 to 10, a water content of 0.1% to 10% by weight, and a tap density of 0.1 to 1 g/ml.

Examples of commercially available carbon black products that can be used in the invention include Black Pearls 2000, 1300, 1000, 900, 905, 800, and 700 and Vulcan XC-72 (from Cabot Corp.); #80, #60, #55, #50, and #35 (from Asahi Carbon Co., Ltd.); #2400B, #2300, #900, #1000, #30, #40, and #10B (from Mitsubishi Chemical Corp.); Conductex SC, RAVEN 150, 50, 40 and 15, and RAVEN-MT-P (from Columbian Carbon); and Ketjen Black EC (from Ketjen Black International Company). Carbon black having been surface treated with a dispersant, etc., resin-grafted carbon black, or carbon black with its surface partially graphitized may be used. Carbon black may previously been dispersed in a binder before being added to a coating composition for magnetic layer formation. The above-enumerated carbon black species can be used either alone or as a combination thereof. Carbon black can be used in an amount of 0.1% to 30% by weight based on the magnetic powder. Carbon black serves for antistatic control, reduction of frictional coefficient, reduction of light transmission, film strength enhancement, and the like. These functions depend on the species. Accordingly, it is understandably possible, or rather desirable, to optimize the kinds, amounts, and combinations of the carbon black species for each layer according to the intended purpose with reference to the above-mentioned characteristics including particle size, DBP absorption, conductivity, pH, and so forth. In selecting carbon black species for use in the magnetic layer, reference can be made, e.g., to Carbon Black Kyokai (ed.), Carbon Black Binran.

Known abrasives mostly having a Mohs hardness of 6 or higher can be incorporated into the magnetic layer. Such abrasives include α-alumina having an -phase content of 90% or more, β-alumina, silicon carbide, chromium oxide, cerium oxide, α-iron oxide, corundum, artificial diamond, silicon nitride, titanium carbide, titanium oxide, silicon dioxide, and boron nitride. These abrasives can be used either alone or as a mixture thereof or as a composite thereof (an abrasive surface treated with another). Existence of impurity compounds or elements, which are sometimes observed in the abrasives, will not affect the effect as long as the content of the main component is 90% by weight or higher. The abrasives preferably have an average particle size of 0.01 to 2 μm. It is desirable for the abrasives to have a narrow size distribution especially for the enhancement of the electromagnetic characteristics. In order to improve durability, abrasives different in particle size may be used in combination, or a single kind of an abrasive having a broadened size distribution may be used to produce the same effect. The abrasives preferably have a tap density of 0.3 to 2 g/cc, a water content of 0.1% to 5% by weight, a pH of 2 to 11, and a specific surface area of 1 to 30 m²/g. The abrasive grains may be needle-like, spherical, cubic or platy. Angular grains are preferred for high abrasive performance.

Examples of commercially available abrasives which can be used in the invention are AKP-12, AKP-15, AKP-20, AKP-30, AKP-50, HIT-20, HIT-30, HIT-55, HIT-60, IHT-70, HIT-80, and HIT-100 (from Sumitomo Chemical Co., Ltd.); ERC-DBM, HP-DBM, and HPS-DBM (from Reynolds Metals Co.); WA10000 (from Fujimi Kenmazai K.K.); UB 20 (from Uyemura & CO., LTD); G-5, Chromex U2, and Chromex U1 (from Nippon Chemical Industrial Co., Ltd.); TF100 and TF140 (from Toda Kogyo Corp.); Beta-Random Ultrafine (from Ibiden Co., Ltd.); and B-3 (from Showa Mining Co., Ltd.).

If necessary, the abrasive can also be incorporated into the nonmagnetic layer thereby to control the surface profile of the upper magnetic layer or the projecting conditions of the abrasive grains on the magnetic layer. Understandably, the particle size and the amount of the abrasive added to the magnetic or nonmagnetic layer should be optimized.

Organic solvents known in the art can be used in the preparation of the coating compositions for the magnetic or nonmagnetic layers. Typical examples of the solvents include ketones, such as acetone, methyl ethyl ketone, methyl isobutyl ketone, diisobutyl ketone, cyclohexanone, isophorone, and tetrahydrofuran; alcohols, such as methanol, ethanol, propanol, butanol, isobutyl alcohol, isopropyl alcohol, and methylcyclohexanol; esters, such as methyl acetate, butyl acetate, isobutyl acetate, isopropyl acetate, ethyl lactate, and glycol acetate; glycol ethers, such as glycol dimethyl ether, glycol monoethyl ether, and dioxane; aromatic hydrocarbons, such as benzene, toluene, xylene, cresol, and chlorobenzene; chlorinated hydrocarbons, such as methylene chloride, ethylene chloride, carbon tetrachloride, chloroform, ethylenechlorohydrin, and dichlorobenzene; N,N-dimethylformamide; and hexane. They can be used either alone or as a mixture at any mixing ratio.

The organic solvent does not always need to be 100% pure and may contain impurities, such as isomers, unreacted matter, by-products, decomposition products, oxidation products, and water. The impurity content is preferably 30% or less, still preferably 10% or less. The organic solvent used in the formation of the magnetic layer and that used in the formation of the nonmagnetic layer are preferably the same in kind but may be different in amount. It is advisable to use a solvent with high surface tension (e.g., cyclohexanone or dioxane) in the formation of the nonmagnetic layer to improve coating stability. Specifically, it is important that the arithmetic mean of the surface tensions of the solvents for the upper magnetic layer be equal to or higher than that for the lower nonmagnetic layer. A solvent with somewhat high polarity is preferred for improving dispersing capabilities for powders. The solvent system preferably contains at least 50% of a solvent having a dielectric constant of 15 or higher. The solubility parameter of the solvent or the solvent system is preferably 8 to 11.

The kinds and amounts of the above-described dispersing agents, lubricants or surface active agents to be used can be decided as appropriate to the character of the layer to which they are added. The following is a few illustrative examples of manipulations using these additives. (i) A dispersing agent has a property of being adsorbed or bonded to fine solid particles via its polar groups. It is adsorbed or bonded via the polar groups mostly to the surface of ferromagnetic metal powder when used in a magnetic layer or the surface of nonmagnetic powder in a nonmagnetic layer. It is assumed that, after once being adsorbed to metal or metal compound particles, an organophosphorus compound, for instance, is hardly desorbed therefrom. As a result, the ferromagnetic metal powder or nonmagnetic powder treated with a dispersing agent appears to be covered with an alkyl group, an aromatic group or the like, which makes the particles more compatible with a binder resin component and more stable in their dispersed state. (ii) Since lubricants exist in a free state, bleeding of lubricants is controlled by using fatty acids differing in melting points between the magnetic layer and the nonmagnetic layer or by using esters different in boiling point or polarity between the magnetic layer and the nonmagnetic layer. (iii) Coating stability is improved by adjusting the amount of the surface active agent. (iv) The amount of the lubricant in the nonmagnetic layer is increased to improve the lubricating effect.

All or part of the additives can be added at any stage of preparing the magnetic or nonmagnetic coating composition for the formation of the magnetic or nonmagnetic layer. For example, the additives can be blended with the ferromagnetic powder before kneading, or be mixed with the ferromagnetic powder, a binder, and a solvent in the step of kneading, or be added during or after the step of dispersing or immediately before coating.

### V. Nonmagnetic Layer

The magnetic recording medium of the invention can have a nonmagnetic layer containing a nonmagnetic powder and a binder between the nonmagnetic support and the magnetic layer. The nonmagnetic powder may be either organic or inorganic. If desired, the nonmagnetic layer may contain carbon black in addition to the nonmagnetic powder. Types of the inorganic nonmagnetic materials include metals, metal oxides, metal carbonates, metal sulfates, metal nitrides, metal carbides, and metal sulfides.

Examples of the inorganic nonmagnetic materials include titanium oxides (e.g., titanium dioxide), cerium oxide, tin oxide, tungsten oxide, ZnO, ZrO₂, SiO₂, Cr₂O₃, α-alumina having an α-phase content of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide. They can be used either individually or in combination. Preferred among them are α-iron oxide and titanium oxide.

The shape of the nonmagnetic powder particles may be any of acicular, spherical, polygonal, and platy shapes. The crystallite size of the nonmagnetic powder is preferably 4 to 500 nm, still preferably 40 to 100 nm. Particles with the crystallite size ranging from 4 to 500 nm provide appropriate surface roughness while securing dispersibility. The nonmagnetic powder preferably has an average particle size of 5 nm to 500 nm. In this preferred range of an average particle size, the particles are satisfactorily dispersible and provide a nonmagnetic layer with appropriate surface roughness. If desired, nonmagnetic powders different in average particle size may be used in combination, or a single kind of a nonmagnetic powder having a broadened size distribution may be used to produce the same effect. When the average particle size falls within the range of 5 to 500 nm, the particles are satisfactorily dispersible and provide a nonmagnetic layer with appropriate surface roughness. A still preferred particle size of the nonmagnetic powder is 10 to 200 nm.

The specific surface area of the nonmagnetic powder preferably ranges from 1 to 150 m²/g, still preferably 20 to 1210 m²/g, even still preferably 50 to 100 m²/g. In the preferred specific surface area range, the nonmagnetic powder provides appropriate surface roughness and is dispersible in a desired amount of a binder. The DBP absorption of the powder is preferably 5 to 100 ml/100 g, still preferably 10 to 80 ml/100 g, even still preferably 20 to 60 ml/100 g. The specific gravity of the powder is preferably 1 to 12, still preferably 3 to 6. The tap density of the powder is preferably 0.05 to 2 g/ml, still preferably 0.2 to 1.5 g/ml. Having the tap density falling within that range, the powder is easy to handle with little dusting and tends to be less liable to stick to equipment. The nonmagnetic powder preferably has a pH of 2 to 11, still preferably between 6 and 9. With the pH ranging between 2 and 11, an increase in frictional coefficient of the magnetic recording medium experienced in a high temperature and high humidity condition or due to release of a fatty acid can be averted. The water content of the nonmagnetic powder is preferably 0.1% to 5% by weight, still preferably 0.2% to 3% by weight, even still preferably 0.3% to 1.5% by weight. Within the preferred water content range, the powder is easy to disperse, and the resulting coating composition has a stable viscosity. The ignition loss of the powder is preferably not more than 20% by weight. The smaller the ignition loss, the better.

The inorganic nonmagnetic powder preferably has a Mohs hardness of 4 to 10 to secure durability. The nonmagnetic powder preferably has a stearic acid adsorption of 1 to 20 μmol/m², still preferably 2 to 15 μmol/m². The heat of wetting of the nonmagnetic powder with water at 25° C. is preferably 200 to 600 erg/m² (200 to 600 mJ/cm²). Solvents in which the nonmagnetic powder releases the recited heat of wetting can be used. The number of water molecules on the nonmagnetic powder at 1000 to 400° C. is suitably 1 to 10 per 10 nm. The isoelectric point of the nonmagnetic powder in water is preferably pH 3 to 9.

It is preferred that the nonmagnetic powder be surface treated to have a surface layer of Al₂O₃, SiO₂, TiO₂, ZrO₂, SnO₂, Sb₂O₃, or ZnO. Among them, preferred for dispersibility are Al₂O₃, SiO₂, TiO₂, and ZrO₂, with Al₂O₃, SiO₂, and ZrO₂ being still preferred. These surface treating substances may be used either individually or in combination. According to the purpose, a composite surface layer can be formed by co-precipitation or a method comprising first applying alumina to the nonmagnetic particles and then treating with silica or vise versa. The surface layer may be porous for some purposes, but a homogeneous and dense surface layer is usually preferred.

Specific examples of commercially available nonmagnetic powders that can be used in the nonmagnetic layer include Nanotite from Showa Denko K.K.; HIT-100 and ZA-G1 from Sumitomo Chemical Co., Ltd.; DPN-250, DPN-250BX, DPN-245, DPN-270BX, DPB-550BX, and DPN-550RX from Toda Kogyo Corp.; titanium oxide series TTO-51B, TTO-55A, TTO-55B, TTO-55C, TTO-55S, and TTO-55D, SN-100, MJ-7, and α-iron oxide series E270, E271, and E300 from Ishihara Sangyo Kaisha, Ltd.; STT-4D, ST-30D, STT-30, and STT-65C from Titan Kogyo K.K.; MT-100S, MT-100T, MT-150W, MT-500B, MT-600B, T-100F, and T-500HD from Tayca Corp.; FINEX-25, BF-1, BF-10, BF-20, and ST-M from Sakai Chemical Industry Co., Ltd.; DEFIC-Y and DEFIC-R from Dowa Mining Co., Ltd.; AS2BM and TiO2P25 from Nippon Aerosil Co., Ltd.; 100A and 500A from Ube Industries, Ltd.; and Y-LOP from Titan Kogyo K.K. and calcined products thereof. Preferred of them are titanium dioxide and α-iron oxide.

Incorporation of carbon black into the nonmagnetic layer is effective in reducing the surface resistivity, decreasing light transmission, and attaining a desired micro Vickers hardness. The nonmagnetic layer generally has a micro Vickers hardness of 25 to 60 kg/mm² (245 to 588 MPa). A preferred micro Vickers hardness for good head contact is 30 to 50 kg/mm² (294 to 490 MPa). A micro Vickers hardness can be measured with a thin film hardness tester (HMA-400 supplied by NEC Corp.) having an indenter equipped with a three-sided pyramid diamond tip, 80° angle and 0.1 μm end radius. For the details of the micro Vickers hardness measurement, refer to HAKUMAKUNO RIKIGAKUTEKI TOKUSEI HYOUKA GIJYUTU, published by Realize Advanced Technology Ltd. Magnetic recording tapes are generally standardized to have an absorption of not more than 3% for infrared rays of around 900 nm. For example, the absorption of VHS tapes is standardized to be not more than 0.8%. Useful carbon black species for these purposes include furnace black for rubber, thermal black for rubber, carbon black for colors, and acetylene black.

The carbon black in the nonmagnetic layer has a specific surface area of 100 to 500 m²/g, preferably 150 to 400 m²/g, a DBP absorption of 20 to 400 ml/100 g, preferably 30 to 200 ml/100 g, and an average particle size of 5 to 80 nm, preferably 10 to 50 nm, still preferably 10 to 40 nm. The carbon black preferably has a pH of 2 to 10, a water content of 0.1 to 10% by weight, and a tap density of 0.1 to 1 g/ml.

Specific examples of commercially available carbon black products for use in the nonmagnetic layer include Black Pearls 2000, 1300, 1000, 900, 800, 880, and 700, and Vulcan XC-72 from Cabot Corp.; #3050B, #3150B, #3250B, #3750B, #3950B, #950, #650B, #970B, #850B, and MA-600 from Mitsubishi Chemical Corp.; Conductex SC and RAVEN 8800, 8000, 7000, 5750, 5250, 3500, 2100, 2000, 1800, 1500, 1255, and 1250 from Columbian Carbon; and Ketjen Black EC from Ketjen Black International Company.

Carbon black having been surface treated with a dispersing agent, etc., resin-grafted carbon black, or carbon black with its surface partially graphitized may be used. Carbon black may previously been dispersed in a binder before being added to a coating composition. Carbon black is used in an amount of 50% by weight or less based on the inorganic powder and 40% by weight or less based on the total weight of the nonmagnetic layer. The above-recited carbon black species can be used either individually or as a combination thereof. In selecting carbon black species for use in the nonmagnetic layer, reference can be made, e.g., to Carbon Black Kyokai (ed.), Carbon Black Binran.

The nonmagnetic layer can contain organic powder according to the purpose. Useful organic powders include acrylic-styrene resin powders, benzoguanamine resin powders, melamine resin powders, and phthalocyanine pigments. Polyolefin resin powders, polyester resin powders, polyamide resin powders, polyimide resin powders, and polyethylene fluoride resin powders are also usable. Methods of preparing these resin powders are disclosed, e.g., in JP-A-62-18564 and JP-A-60-255827.

The detailed description given above about the magnetic layer applies to the nonmagnetic layer, including selection of the kinds and amounts of binder resins, lubricants, dispersing agents, other additives, and solvents and methods of dispersing. In particular, known techniques with regard to the amounts and kinds of binder resins, additives, and dispersing agents to be used in a magnetic layer are applicable to the formation of the nonmagnetic layer.

If desired, an undercoat for adhesion improvement may be provided between the nonmagnetic support and the nonmagnetic layer or the magnetic layer. The undercoat is usually formed of an organic solvent-soluble polyester resin.

As previously stated, the nonmagnetic support preferably has a thickness of 3 to 80 μm, still preferably 3 to 50 μm, even still preferably 3 to 10 μm. The thickness of the undercoat, if provided, is usually 0.01 to 0.8 μm, preferably 0.02 to 0.6 μm.

The thickness of the magnetic layer should be optimized according to the saturation magnetization and the gap of the magnetic head used and the recording signal band. It usually ranges from 10 to 150 nm, preferably 10 to 100 nm, still preferably 20 to 80 nm, even still preferably 30 to 80 nm, with a coefficient of thickness variation being preferably within +50%, still preferably ±30%. The magnetic layer may have a single layer structure or a multilayer structure composed of two or more magnetic sublayers different in magnetic characteristics. In the latter case, known technology with reference to a multilayer magnetic layer structure can be applied.

The thickness of the nonmagnetic layer is 0.1 to 3.0 μm, preferably 0.3 to 2.0 μm, still preferably 0.5 to 1.5 μm. The nonmagnetic layer manifests its effects as long as it is substantially nonmagnetic. Incorporation, either intentional or unintentional, of a small amount of a magnetic substance in the nonmagnetic layer does not impair the effects of the present invention. Such a layer structure is understandably construed as being within the scope of the present invention. The language “substantially nonmagnetic” as referred to above is intended to mean that the nonmagnetic layer has a residual magnetic flux density of 10 m·T or less or a coercive force of 7.96 kA/m (100 Oe) or less. Desirably, the nonmagnetic layer has neither residual magnetic flux density nor coercive force.

The average thickness δ of the magnetic layer and its standard deviation a are determined as follows.

A resin embedded block of the magnetic tape is sectioned along the longitudinal direction of the tape on an ultramicrotome to prepare an ultrathin section of about 80 to 100 nm in thickness. The cut area of the magnetic tape of the section is photographed, approximately centered at the magnetic layer/nonmagnetic layer interface, under a transmission electron microscope (TEM H-9000 from Hitachi, Ltd.) at a magnification of 100,000 times serially over a length of 25 to 30 μm along the longitudinal direction of the tape. The surface of the magnetic layer and the interface between the magnetic layer and the nonmagnetic layer as visually defined are traced, and the outline of the magnetic layer is scanned into an image processor KS Imaging Systems ver. 3 from Carl Zeiss. The distance between the surface of the magnetic layer and the magnetic layer nonmagnetic layer interface is measured at about 2100 points for every 12.5 nm in the longitudinal direction of the tape to obtain an average magnetic layer thickness δ and its standard deviation σ. Scaling in scanning and image analysis is corrected using a line of 2 cm in absolute length.

### VI. Backcoat

The magnetic recording medium of the invention preferably has a backcoat on the opposite side of the nonmagnetic support with respect to the magnetic layer. The backcoat preferably contains carbon black and inorganic powder. The formulations of the binder and various additives for the magnetic layer and the nonmagnetic layer also apply to the backcoat. The backcoat preferably has a thickness of 0.9 μm or smaller, still preferably 0.1 to 0.7 μm.

### VII. Method of Making

The process of producing the magnetic recording medium according to the present invention includes the steps of preparing a coated web by applying a magnetic coating composition containing a ferromagnetic powder and a binder to at least one side of a nonmagnetic support, winding the coated web into a roll, and calendering the coated web unwound from the roll.

Coating compositions for forming the magnetic layer and the nonmagnetic layer are each prepared by a method including at least the steps of kneading and dispersing and, if desired, the step of mixing which is provided before or after the step of kneading and/or the step of dispersing. Each step may be carried out in two or more divided stages. All the materials, including the magnetic powder, nonmagnetic powder, binder, carbon black, abrasive, antistatic, lubricant, and solvent, can be added at the beginning of or during any step. Individual materials may be separately dispersed in a dispersing medium and added in any step. Individual materials may be added in divided portions in two or more steps. For example, a polyurethane resin may be added dividedly in the kneading step, the dispersing step, and a mixing step which is provided for adjusting the viscosity of the dispersion. Known techniques for coating composition preparation can be applied as a part of the method to achieve the object of the invention. The kneading step is preferably performed using a kneading machine with high kneading power, such as an open kneader, a continuous kneader, a pressure kneader, and an extruder. For the details of the kneading operation, reference can be made to JP-A-1-106338 and JP-A-1-79274. In the step of dispersing, dispersing beads can be used. High specific gravity dispersing beads, such as glass beads, zirconia beads, titania beads, and steel beads, are suitable. The size and mixing ratio of the dispersing beads should be optimized. Known dispersing equipment can be used.

In the step of obtaining a coated web, a magnetic coating composition is applied to a moving nonmagnetic support to form a magnetic layer of a desired thickness. A plurality of magnetic coating compositions may be applied successively or simultaneously. A nonmagnetic coating composition and a magnetic coating composition maybe applied successively or simultaneously. Coating equipment includes an air doctor (air knife) coater, a blade coater, a rod coater, an extrusion coater, a squeegee coater, an impregnation coater, a reverse roll coater, a transfer roll coater, a gravure coater, a kiss roll coater, a cast coater, a spray coater, and a spin coater. For the details of coating techniques, reference can be made to Saishin Coating Gijyutsu, published by Sogo Gijyutsu Center, 1983.

The ferromagnetic powder in the applied magnetic coating composition may be oriented using cobalt magnets or a solenoid. In the case of disk media, although sufficiently isotropic orientation could sometimes be obtained without orientation using an orientation apparatus, it is preferred to use a known random orientation apparatus in which cobalt magnets are obliquely arranged in an alternate manner or an alternating magnetic field is applied with a solenoid. In using a ferromagnetic metal powder, the “isotropic orientation” is preferably in-plane, two-dimensional random orientation but may be in-plane and vertical three-dimensional random orientation. It is also possible to provide a disk with circumferentially isotropic magnetic characteristics by vertical orientation in a known manner, for example, by using facing magnets with their polarities opposite. Vertical orientation is particularly preferred for high density recording. Circumferential orientation may be achieved by spin coating.

It is preferred that the temperature and amount of drying air and the coating speed be adjusted to control the drying position of the coating layer. The coating speed is preferably 20 to 1000 m/min, and the drying air temperature is preferably 60° C. or higher. The coating layer may be pre-dried before entering the magnet zone. In this regard, the drying air temperature should not exceed the glass transition temperature (Tg) of the nonmagnetic support.

The coated web thus obtained is once wound on a take-up roll and then unwound from the take-up roll to be subjected to calendering.

Calendering is conducted using, for example, supercalender rolls. By the calendering, not only the surface smoothness increases, but also the voids generated by the solvent being released on drying disappear to increase the packing density of the ferromagnetic powder in the magnetic layer thereby providing a magnetic recording medium with improved electromagnetic characteristics. It is preferable to carry out the calendering while varying the calendering conditions according to the surface smoothness of the coated web.

There are cases in which an unrolled coated web wound around a take-up roll shows a general decrease in gloss over its length toward the outer end of the roll, which means quality variation in the longitudinal direction of the web. Gloss is known to be correlated with, or inversely related to, surface roughness Ra. If the coated web with such variation in surface smoothness is calendered under a constant condition, for example a constant calender roll pressure, this means that no countermeasure is taken against the surface smoothness variation ascribed to the winding of the coated web. It naturally follows that a finally obtained recording medium suffers from quality variations in its longitudinal direction.

Accordingly, calendering is preferably carried out while changing the conditions, such as a calender roll pressure, so as to offset the variation in smoothness in the longitudinal direction ascribed to the winding of the coated web. More specifically, it is preferred to decrease the calender roll pressure with processing time, i.e., toward the inner end of the web being unrolled. As a result of the inventors' examination, it has been found that the gloss (surface smoothness) reduces with a reduction in calender roll pressure. Thus, the variation in smoothness in the longitudinal direction ascribed to the winding of coated web is offset to provide a final produce with uniform quality over its whole length.

The same effect is produced by controlling other calendering conditions, such as calender roll temperature, calendering speed, and calender roll tension, in place of, or in addition to, the calender roll pressure. Taking the characteristics of the particulate medium into consideration, it is advisable to control the calender roll pressure and/or temperature. A reduction in calender roll pressure and/or temperature results in a reduction in surface smoothness of the final product. Conversely, an increase in calender roll pressure and/or temperature results in an increase in surface smoothness of the final product.

Separately, the magnetic recording medium obtained after the calendering can be subjected to thermal treatment to cause the thermosetting resin binder to complete cure. Conditions of the thermal treatment are decided as appropriate to the formulation of the coating composition for magnetic layer formation. For example, the thermal treatment is carried out at 350 to 100° C., preferably 500 to 80° C., for 12 to 72 hours, preferably 24 to 48 hours.

Calendering is carried out with calender rolls of heat-resistant plastics, such as epoxy resins, polyimide, polyamide and polyamide-imide. Metallic rolls are also usable.

It is preferred for the magnetic recording medium of the invention to have extremely good surface smoothness with a three-dimensional mean surface roughness SRa of 0.1 to. 4 nm, still preferably 1 to 3 nm (cut-off length: 0.25 mm). Calendering conditions that can be adapted to achieve such high smoothness are: a roll temperature of 60° to 100° C., preferably 70° to 100° C., still preferably 800 to 100° C., and a pressure of 100 to 500 kg/cm (98 to 490 kN/m), preferably 200 to 450kg/cm (196 to 441 kN/m), still preferably 300 to 400 kg/cm (294 to 392 kN/m).

The resulting magnetic recording medium is slit to width by means of a slitter, etc. While any type of slitters is usable, those having a plurality of sets of a rotating upper or male knife and a rotating lower or female knife are preferred. The slitting speed, depth of engagement between the upper and lower knives, upper knife to lower knife ratio of peripheral speed, hour of continuous use of the knives, and the like are decided appropriately.

### VIII. Physical Characteristics

The magnetic layer of the magnetic recording medium according to the invention preferably has a saturation flux density of 100 to 400 m·T and a coercive force Hc of 143.2 to 318.3 kA/m (1800 to 4000 Oe), still preferably 159.2 to 278.5 kA/m (2000 to 3500 Oe). The narrower the coercive force distribution, the more preferred. Accordingly, SFD and SFDr are preferably 0.6 or smaller, still preferably 0.2 or smaller.

The magnetic recording medium of the invention has a frictional coefficient of 0.50 or less, preferably 0.3 or less, on a head at temperatures of −10° to 40° C. and humidities of 0% to 95%. The surface resistivity on the magnetic surface is preferably 104 to 10⁸ Ω/sq. The static potential is preferably −500 to +500 V. The magnetic layer preferably has an elastic modulus at 0.5% elongation of 0.98 to 19.6 GPa (100 to 2000 kg/mm²) in every in-plane direction and a breaking strength of 98 to 686 Mpa (10 to 70 kg/mm²). The magnetic recording medium preferably has an elastic modulus of 0.98 to 14.7 GPa (100 to 1500 kg/mm²) in every in-plane direction, a residual elongation of 0.5% or less, and a thermal shrinkage of 1% or less, still preferably 0.5% or less, even still preferably 0.1% or less, at temperatures of 100° C. or lower.

The glass transition temperature (maximum loss elastic modulus in dynamic viscoelasticity measurement at 110 Hz) of the magnetic layer is preferably 50° to 180° C., and that of the nonmagnetic layer is preferably 0° to 180° C. The loss elastic modulus preferably ranges from 1×10⁷ to 8×10⁸ Pa (1×10⁸ to 8×10⁹ dyne/cm²). The loss tangent is preferably 0.2 or lower. Too high a loss tangent easily leads to a tack problem. It is desirable that these thermal and mechanical characteristics be substantially equal in all in-plane directions with differences falling within 10%.

The residual solvent content in the magnetic layer is preferably 100 mg/m² or less, still preferably 10 mg/m² or less. The magnetic layer and the nonmagnetic layer each preferably have a void of 30% by volume or less, still preferably 20% by volume or less. While a lower void is better for high output, there are cases in which a certain level of void is recommended. For instance, a relatively high void is often preferred for disk media, which put weight on durability against repeated use.

In the case of a dual layer structure as in the present invention, the physical properties can be varied between the lower nonmagnetic layer and the upper magnetic layers according to the purpose. For example, the elastic modulus of the magnetic layer can be set relatively high to improve running durability, while that of the nonmagnetic layer can be set relatively low to improve head contact.

### IX. Read and Write

While the method of recording and reproducing information on the magnetic tape of the present invention is not particularly restricted, it is preferred that information be written at a maximum linear recording density of 200 kfci or higher and read with an MR head.

An MR head utilizes a magnetoresistive effect produced in response to magnetic flux variations detected through the thin film magnetic head. An MR head has an advantage of providing a large read output that has not been obtained with conventional inductive heads. This is chiefly because the read output of an MR head is based on variations of the magnetoresistance so that it is independent of the relative speed of the magnetic recording medium to the head. Excellent read characteristics can be obtained in a high frequency region by use of such an MR head as a read head.

Compared with conventional magnetic recording tapes, the magnetic tape of the invention realizes reproduction of even those signals written in a high frequency region at high C/N by using an MR head as a read head. Accordingly, the magnetic tape of the invention is suited for high density recording of computer data.

### EXAMPLES

The present invention will now be illustrated in greater detail with reference to Examples, but it should be understood that the invention is not construed as being limited thereto. Unless otherwise noted, all the parts are by weight.

### (1) Preparation of Magnetic Coating Composition 1 for the Formation of Upper Magnetic Layer and Nonmagnetic Coating Composition for the Formation of Lower Nonmagnetic Layer

Formulation of magnetic coating composition:

| | |
|---|---|
| Ferromagnetic metal powder (Fe/Co = 100/30 (atomic | 100 parts |
| ratio); Hc: 189.600 kA/m (2400 Oe); S_{BET}: 70 m²/g; | |
| average length: 45 nm; crystallite size: 13 nm (130 A); | |
| σs: 110 A · m²/kg (110 emu/g); surface treating | |
| compound: Al₂O₃, Y₂O₃) | |
| Vinyl chloride resin (MR-110, from Zeon Corp.; —SO₃Na | 12 parts |
| content: 5 × 10⁻⁶ eq/g; degree of polymerization: 350; | |
| epoxy group content: 3.5 wt % in terms of monomer unit)) | |
| Polyester polyurethane resin (UR8200 from Toyobo) | 4 parts |
| Alpha-alumina (average particle size: 0.1 μm) | 2 parts |
| Carbon black (average particle size; 0.08 μm) | 0.5 parts |
| Stearic acid | 2 parts |
| Methyl ethyl ketone | 90 parts |
| Cyclohexane | 30 parts |
| Toluene | 60 parts |

Formulation of nonmagnetic coating composition:

| | |
|---|---|
| Nonmagnetic powder α-Fe₂O₃ hematite (length: 0.15 μm; | 80 parts |
| S_{BET}: 110 m²/g; pH: 9.3; tap density: 0.98 g/ml; surface | |
| treating compound: Al₂O₃, SiO₂) | |
| Carbon black (from Mitsubishi Chemical Corp.; average | 20 parts |
| primary particle size: 16 nm; DBP absorption: | |
| 80 ml/100 g; pH: 8.0; S_{BET}: 250 m²/g; volatile content: | |
| 1.5%) | |
| Vinyl chloride resin (MR-110, from Zeon Corp.) | 12 parts |
| Polyester polyurethane resin (UR8200 from Toyobo) | 12 parts |
| Stearic acid | 2 parts |
| Methyl ethyl ketone | 150 parts |
| Cyclohexane | 50 parts |
| Toluene | 50 parts |

The above components of each of the magnetic coating composition and the nonmagnetic coating composition were kneaded in a kneader and then dispersed in a sand mill. To the dispersion for upper magnetic layer was added 1.6 parts of sec-butyl stearate. To the dispersion for lower nonmagnetic layer was added 3 parts of a polyisocyanate compound (Coronate L, from Nippon Polyurethane Industry Co., Ltd.). To each of the dispersions was further added 40 parts of a methyl ethyl ketone/cyclohexanone mixed solvent, followed by stirring and filtration through a filter having an average opening size of 1 μm to prepare a magnetic coating composition (designated magnetic coating composition 1) and a nonmagnetic coating composition.

### (2) Preparation of Backcoating Composition

| | |
|---|---|
| Fine carbon black (average particle size: 20 nm) | 100 parts |
| Coarse carbon black (average particle size: 270 nm) | 10 parts |
| Nitrocellulose | 100 parts |
| Polyester polyurethane resin | 30 parts |
| Dispersing agent | |
| Copper oleate | 10 parts |
| Copper phthalocyanine | 10 parts |
| Barium sulfate (precipitated) | 5 parts |
| Methyl ethyl ketone | 500 parts |
| Toluene | 500 parts |
| Alpha-alumina (average particle size: 0.13 μm) | 0.5 parts |

The above components were kneaded in a continuous kneader and then dispersed in a sand mill for 2 hours. To the resulting dispersion were added 40 parts of polyisocyanate (Coronate L, from Nippon Polyurethane Industry Co., Ltd.) and 1000 parts of methyl ethyl ketone, followed by agitation and filtration through a filter having an average pore size of 1 μm to prepare a coating composition for backcoat.

### (3) Preparation of Nonmagnetic Support

Nonmagnetic supports of a material shown in Table 1 were prepared by stretching a polyethylene naphthalate (PEN) film at a varied stretch ratio so as to control the Young's moduli in the longitudinal direction and the transverse direction. The nonmagnetic supports for use in Examples 1 to 7, and Comparative Examples 1 and 2 were heat-treated under the conditions shown in Table 1. The nonmagnetic supports were cooled to the room temperature after the heat treatment. The nonmagnetic supports for use in Examples 4 and 5, and Comparative Examples 1 and 2 were prepared by forming a 50 nm thick Al₂O₃ reinforcing layer on a surface of the nonmagnetic support to which the magnetic layer was to be formed and a surface of the nonmagnetic support opposite thereto by vacuum deposition in a vacuum deposition system under conditions of maximum angle of incidence of 600, film running speed of 1.5 m/min, and electron gun power of 16 kW.

TABLE 1

| | | | | | | Young's | Young's Modulus of |
|---|---|---|---|---|---|---|---|
| | | Tg of | | | | Modulus | (Nonmagnetic support + Reinforcing |
| | | Support | Thickness | Heat | Reinforcing | (MD/TD) | Layer) |
| | Support | (° C.) | (μm) | Treatment | Layer | (GPa) | (MD/TD) (GPa) |
| Ex. 1 | PEN | 120 | 5 | At 90° C. for | No | 6.6/8.8 | |
| | | | | one day | | | |
| Ex. 2 | PEN | 120 | 5 | At 90° C. for | No | 6.6/8.8 | |
| | | | | three days | | | |
| Ex. 3 | PEN | 120 | 5 | At 70° C. for | No | 6.6/8.8 | |
| | | | | one days | | | |
| Ex. 4 | PEN | 120 | 5 | At 90° C. for | Yes | 6.6/8.8 | 8.6/11.3 |
| | | | | one day | | | |
| Ex. 5 | PEN | 120 | 5 | At 90° C. for | Yes | 8.3/6.2 | 9.8/8.9 |
| | | | | one day | | | |
| Ex. 6 | PEN | 120 | 5 | At 90° C. for | No | 5.5/12.7 | |
| | | | | one day | | | |
| Ex. 7 | PEN | 120 | 5 | At 90° C. for | No | 7.5/7.5 | |
| | | | | one day | | | |
| Comp. | PEN | 120 | 5 | At 90° C. for | Yes | 8.5/5.8 | 9.8/8.3 |
| Ex. 1 | | | | one day | | | |
| Comp. | PEN | 120 | 5 | At 90° C. for | Yes | 7.8/5.6 | 9.8/7.8 |
| Ex. 2 | | | | one day | | | |
| Comp. | PEN | 120 | 5 | No | No | 6.6/8.8 | |
| Ex. 3 | | | | | | | |

### Preparation of Magnetic Tape

### Examples 1 to 7 and Comparative Examples 1 to 3

The nonmagnetic coating composition 1 was applied to a web of the nonmagnetic support of Table 1 to a dry thickness of 1.0 μm and dried at 100° C. to form a lower nonmagnetic layer. The magnetic coating composition 1 was then applied wet-on-dry to a dry thickness of 0.08 μm and dried at 100° C. While the magnetic layer was wet, the coated web was subjected to magnetic orientation using magnets of 300 mT (3000 Gauss). The backcoating composition was applied to the opposite side of the support to a dry thickness of 0.5 μm, followed by drying to form a backcoat. A magnetic recording laminate roll in which a lower layer and a magnetic layer were provided on one surface of the nonmagnetic support and the backcoat was provided on a surface opposite thereto was acquired. A surface smoothing treatment was carried out on 7-roll calender composed of metal rolls under conditions of a calendering speed of 100 m/min, a linear pressure of 300 kg/cm, and a roll temperature of 90° C. The calendered web was thermally treated at 70° C. for 24 hours to complete curing. The coated web was slit to ½ inch width and the coated web of 650 m was wound on an LTO-G3 cartridge to obtain a magnetic tape cartridge.

### Measurements:

(a) Measurement of Temperature Expansion Coefficient and Humidity Expansion Coefficient

### (Measurement of Temperature Expansion Coefficient)

A magnetic tape of ½ inch width was cut into specimens each having 300 mm length. A measurer in which Laser Scan Micrometer manufactured by KEYENCE CORPORATION was used as a measurer. A change of the tape was measured by changing a temperature between 10 to 45° C. under a given environment of 50% RH by means of the measurer to which a load of 5 g was applied by setting the specimen. The temperature expansion coefficient was calculated from equation:

Temperature expansion coefficient=(change of tape width)/(initial tape width)/(change of temperature)

### (Measurement of Humidity Expansion Coefficient)

The tape was put in a chamber controlled under a given environment of 25° C. and the temperature was changed between 10% RH to 80% RH. The change of a tape width was measured by using the same measurer. The humidity expansion coefficient was calculated from equation:

### Humidity expansion coefficient=(change of tape width)/(initial tape width)/(change of temperature)

### (Measurement of Creep Change)

A load of 1N was applied to the specimen in a longitudinal direction thereof under a given dry environment of 60° C. A change in tape width was measured for 50 hours by using the same measurer. An amount of creep was calculated from equation:

Amount of creep=|(change of tape width)|/(initial tape width) (| | denotes an absolute value)

(b) Measurement of Error Rate (in Ambient and High Humidity/Temperature Environments)

The ½ in. tape was run on a drum tester at a relative tape/head speed of 2 m/sec, and signals were written using, as a read head, an MIG head having a saturation magnetization of 1.3 T, a gap length of 0.2 μm, and a track width of 10 μm, and, as a write head, a GMR head having a track width of 1.5 μm and a shield gap length of 0.16 μm. The recording current was adjusted to the optimum recording current of each tape.

A 1 Mbit M-sequence pattern was modulated in a 16/17 encoding system and written at a linear recording density of 400 kbpi at 25° C. and 50% RH. The waveform was reproduced and captured in an ambient environment (25° C., 50% RH) or a high temperature and humidity environment (40° C., 80% RH). Asoftware channel (EPR4ML) was used to process the signals and calculate the error rates in the 25° C. 50% RH and 40° C. 80% RH conditions. Error rate dependence on environmental conditions was evaluated in terms of digit as calculated according to the following formula:

log₁₀(error rate at 40° C. 80% RH/error rate at 25° C. 50% RH) (digit)

The results obtained are shown in Table 2. Table 2 also shows the Young's modulus (MD) of the magnetic tapes. Error rate changes of one or less in terms of digit are regarded satisfactory. Changes of 0.5 or less are more satisfactory. Changes exceeding 1 are unfavorable.

### Reproduction Characteristic of High-Temperature Preservation

Recording and reproducing on an outer side and a center side of a reel of the magnetic tape cartridge specimen for use in (Examples 1 to 7) and (Comparative Examples 1 to 3) were performed by using an LTO-G3 drive, thereby setting it as a reproduction characteristic in initial preservation. After the magnetic tap cartridge was preserved under an environment of 60° C. and 90%RH for 336 hours, recording signals at the outer side and the center side (the same position as that before preservation) of the reel were reproduced, and a characteristic of the outer side of the reel before the preservation was set to 0 dB. A smaller value was selected from the obtained value at the outer side of the reel after the preservation and the obtained value at the center side of the reel after the preservation as a reproduction characteristic after the preservation. A magnetic tape cartridge having a reproduction characteristic after the preservation which was smaller than −3 dB was considered to be in an NG state.

TABLE 2

| | | | | | | Reproduction |
|---|---|---|---|---|---|---|
| | Young's | Temperature | Humidity | | | characteristic |
| | modulus | Expansion | Expansion | Creep | Log(error | after the |
| | of | Coefficient | Coefficient | Amount | rate at | preservation |
| | Magnetic | of Magnetic | of Magnetic | Of | 40° C. 80% RH/ | under environment |
| | Tape MD | Tape | Tape | Magnetic | error rate at | of 60° C., 90% RH for |
| | (GPa) | (×10⁻⁶/° C.) | (×10⁻⁶/% RH) | Tape (%) | 25° C. 50% RH) | 336 hours (dB) |
| Ex. 1 | 6.9 | 7 | 5 | 0.03 | 0.38 | −1.9 |
| Ex. 2 | 6.9 | 7 | 5 | 0.01 | 0.42 | −1.1 |
| Ex. 3 | 6.9 | 7 | 5 | 0.06 | 0.39 | −2.7 |
| Ex. 4 | 6.9 | 7 | 0 | 0.03 | 0.21 | −1.8 |
| Ex. 5 | 8.7 | 10 | 4 | 0.03 | 0.55 | −2.1 |
| Ex. 6 | 5.8 | 0 | 3 | 0.03 | 0.28 | −2.3 |
| Ex. 7 | 7.9 | 7 | 7 | 0.03 | 0.69 | −1.9 |
| Comp. | 8.9 | 12 | 5 | 0.03 | 1.25 | −1.9 |
| Ex. 1 | | | | | | |
| Comp. | 8.1 | 7 | 8 | 0.03 | 1.65 | −2.3 |
| Ex. 2 | | | | | | |
| Comp. | 6.9 | 7 | 5 | 0.07 | 0.37 | −4.3 |
| Ex. 3 | | | | | | |

This application is based on Japanese Patent application JP 2006-91796, filed Mar. 29, 2006, the entire content of which is hereby incorporated by reference, the same as if set forth at length.

What is claimed is:

1. A magnetic tape comprising:
a nonmagnetic support;
a substantially nonmagnetic layer containing nonmagnetic powder and a binder; and
a magnetic layer containing ferromagnetic powder and a binder, in this order,
wherein the magnetic tape has a coefficient of temperature expansion of from 0 to 10×10⁻⁶/° C. and a coefficient of humidity expansion of 0 to 7×10⁻⁶/% RH each in a transverse direction of the magnetic tape, and the magnetic tape has a dimensional deformation amount of from 0.01 to 0.06% in the transverse direction in case of applying a tensile stress of 1N to the magnetic tape at 60° C. for 50 hours in a longitudinal direction of the magnetic tape.

2. The magnetic tape according to claim 1, which has a Young's modulus of 6 GPa or higher in the longitudinal direction of the magnetic tape.

3. The magnetic tape according to claim 1, wherein the nonmagnetic support has a Young's modulus of 6.0 GPa or more in a longitudinal direction of the nonmagnetic support.

4. The magnetic tape according to claim 1, wherein the nonmagnetic support has a Young's modulus of 7.0 GPa or more in a longitudinal direction of the nonmagnetic support.

5. The magnetic tape according to claim 1, wherein the nonmagnetic support has a Young's modulus of 8.0 GPa or more in a transverse direction of the nonmagnetic support.

6. The magnetic tape according to claim 3, wherein the nonmagnetic support has a Young's modulus of 8.0 GPa or more in a transverse direction of the nonmagnetic support.

7. The magnetic tape according to claim 4, wherein the nonmagnetic support has a Young's modulus of 8.0 GPa or more in a transverse direction of the nonmagnetic support.

8. The magnetic tape according to claim 1, wherein the nonmagnetic support has a Young's modulus of 9.0 GPa or more in a transverse direction of the nonmagnetic support.

9. The magnetic tape according to claim 3, wherein the nonmagnetic support has a Young's modulus of 9.0 GPa or more in a transverse direction of the nonmagnetic support.

10. The magnetic tape according to claim 1, wherein the nonmagnetic support has a Young's modulus of 11.0 GPa or more in a transverse direction of the nonmagnetic support.

11. The magnetic tape according to claim 3, wherein the nonmagnetic support has a Young's modulus of 11.0 GPa or more in a transverse direction of the nonmagnetic support.

12. The magnetic tape according to claim 1, wherein the magnetic layer has a dry thickness of from 10 to 100 nm and a coercive force of 159.2 kA/m or higher.

13. The magnetic tape according to claim 1, further comprising: a reinforcing layer containing a metallic material selected from metals, semimetals, alloys, and their oxides and composites, provided on at least one side of the nonmagnetic support.

14. The magnetic tape according to claim 13, wherein the reinforcing layer is provided on both sides of the nonmagnetic support.

15. The magnetic tape according to claim 13, wherein the reinforcing layer has a thickness of from 20 to 500 nm.

16. The magnetic tape according to claim 13, wherein the reinforcing layer has a thickness of from 20 to 300 nm.

17. The magnetic tape according to claim 13, wherein the reinforcing layer contains at least one of Al, Cu, Zn, Sn, Ni, Ag, Co, Fe, Mn, Si, Ge, As, Sc and Sb.
